(19) United States
(12) Patent Application Publication
(10) Pub. No.: US 2012/0248357 A1
(43) Pub. Date: Oct. 4, 2012

(54) SOLENOID VALVE FOR BRAKE SYSTEM

(75) Inventor: Jae Young JEON, Gyeonggi-do (KR)

(73) Assignee: MANDO CORPORATION

(21) Appl. No.: 13/432,990

(22) Filed: Mar. 28, 2012

(30) Foreign Application Priority Data
Mar. 28, 2011 (KR) 10-2011-0027298

(51) Int. Cl. F16K 31/06

(52) U.S. Cl. 251/129.15

(57) ABSTRACT

Disclosed is a solenoid valve for a brake system which has a simple structure, thereby being capable of achieving easy machining and assembly and reducing cost. The solenoid valve includes a sleeve fitted in a modulator block, an armature slidably disposed in the sleeve, a magnet core fitted in the sleeve at one side of the sleeve, to generate an electromagnetic force causing the armature to slide, a seat housing fitted in the sleeve at the other side of the sleeve and formed with oil inlet and outlet passages, and a valve seat disposed within the seat housing and formed with an orifice to be opened or closed in accordance with sliding of the armature. The armature includes a shim core disposed in the armature, to prevent generation of a residual electromagnetic force. The shim core is protruded toward the magnet core beyond the armature.

### CROSS-REFERENCE TO RELATED APPLICATIONS

This application claims the benefit of Korean Patent Application No. 2011-27298, filed on Mar. 28, 2011 in the Korean Intellectual Property Office, the disclosure of which is incorporated herein by reference.

### BACKGROUND

1. Field

Embodiments of the present invention relate to a solenoid valve for a brake system which has a simple structure, thereby being capable of achieving easy machining and assembly and reducing cost.

2. Description of the Related Art

A vehicle is essentially provided with a brake system for braking. Recently, a variety of brake systems to achieve stronger and stabilized brake force have been proposed.

Examples of brake systems include an anti-lock brake system (ABS) that prevents wheel slippage during braking, a brake traction control system (BTCS) that prevents sudden unintended acceleration of a vehicle or slippage of driving wheels upon sudden acceleration, and a vehicle dynamic control system (VDCS) that is a combination of an ABS and BTCS and stably maintains traveling of a vehicle by controlling brake oil pressure.

In the case of the ABS, which is applied to vehicles, a plurality of solenoid valves is provided. The solenoid valves are installed at a hydraulic line extending from a master cylinder to a wheel cylinder or a hydraulic line returning from the side of the wheels, to control hydraulic pressure for braking through an opening or closing operation.

An example of such a solenoid valve is illustrated in FIG. 1. As shown in FIG. 1, the solenoid valve may be of a normally closed type or a normally open type. In the case of the normal close type, the solenoid valve includes an armature 1, a sleeve 2, a magnet core 3, a seat housing 4, a valve housing 5, a valve seat 6, and a coil 7.

When power is applied to the normal close type solenoid valve, an electromagnetic force is generated between the magnet core 3 and the coil 7. As a result, the armature 1 is moved toward the magnet core 3, so that a ball 8 disposed between the armature 1 and the valve seat 6 is moved, thereby opening an internal oil passage in the solenoid valve. On the other hand, when power is released, the armature 1 is returned to an original position thereof by a return spring 9 provided between the magnet core 3 and the armature 1.

In the above-mentioned conventional brake system, however, there may be occasion that, when the armature 1 is returned to the original position thereof in accordance with cut-off of current, the response of the armature 1 may be delayed due to residual electromagnetic force. In order to avoid such a phenomenon, a washer-shaped sol-shim 1a is installed on the armature 1 in a space between the magnet core 3 and the armature 1. In this case, however, it may be impossible to achieve easy assembly and manufacture because the sol-shim 1a has a thin metal structure.

### SUMMARY

Therefore, it is an aspect of the present invention to provide a solenoid valve for a brake system which has a simple structure, thereby being capable of achieving easy machining and assembly and reducing cost.

Additional aspects of the invention will be set forth in part in the description which follows and, in part, will be obvious from the description, or may be learned by practice of the invention.

In accordance with one aspect of the present invention, a solenoid valve for a brake system includes a sleeve fitted in a modulator block, an armature slidably disposed in the sleeve, a magnet core fitted in the sleeve at one side of the sleeve, to generate an electromagnetic force causing the armature to slide, a seat housing fitted in the sleeve at the other side of the sleeve and formed with an oil inlet passage and an oil outlet passage, and a valve seat disposed within the seat housing and formed with an orifice to be opened or closed in accordance with sliding of the armature, wherein the armature includes a shim core disposed in the armature in a longitudinal direction of the armature, to prevent generation of a residual electromagnetic force, and the shim core is protruded toward the magnet core beyond the armature.

The armature and the shim core may be formed through insert molding.

The shim core may have a cylindrical shape, and may have an end contacting a ball to open or close the orifice.

The shim core may be a non-magnetic body.

In accordance with another aspect of the present invention, a solenoid valve for a brake system includes a sleeve fitted in a modulator block, an armature slidably disposed in the sleeve, a magnet core fitted in the sleeve at one side of the sleeve, to generate an electromagnetic force causing the armature to slide, a seat housing fitted in the sleeve at the other side of the sleeve and formed with an oil inlet passage and an oil outlet passage, a valve seat disposed within the seat housing and formed with an orifice to be opened or closed in accordance with sliding of the armature, and a shim core formed in the armature through insert molding while having a cylindrical shape, the shim core having an end protruded into a space facing the magnet core, and an opposite end contacting the orifice.

The shim core may be made of SUS.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating a solenoid valve in a conventional brake system; and

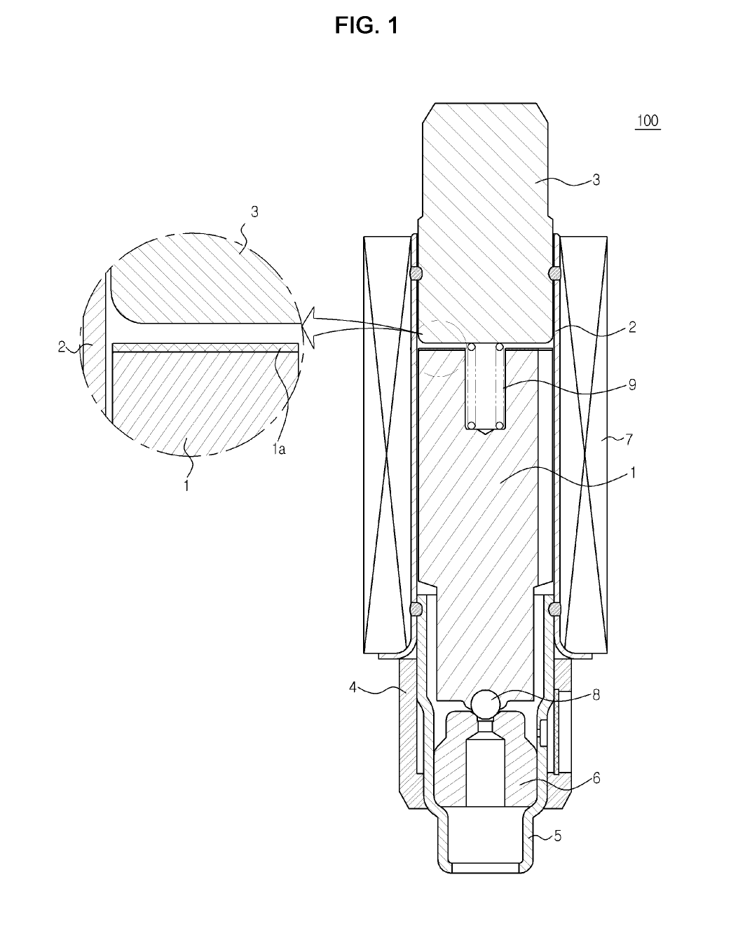

FIG. 2 is a view illustrating a solenoid valve according to an embodiment of the present invention.

### DETAILED DESCRIPTION

Reference will now be made in detail to the embodiments of the present invention, examples of which are illustrated in the accompanying drawings, wherein like reference numerals refer to like elements throughout.

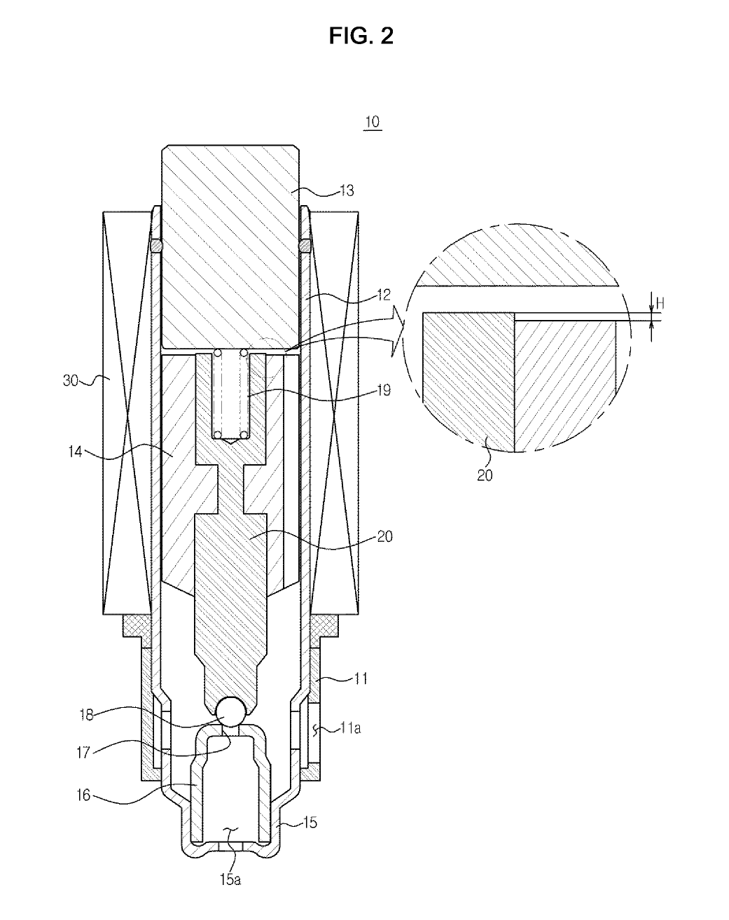

FIG. 2 is a view illustrating a solenoid valve for a brake system according to an exemplary embodiment of the present invention.

Referring to FIG. 2, the solenoid valve, which is designated by reference numeral “10”, includes a valve housing 11 fitted in a modulator block, a sleeve 12 fitted in the valve housing 11, a magnet core 13 fitted in the sleeve 12 opposite to the valve housing 11, and an armature 14 slidably disposed in the sleeve 12.

A seat housing 15 is provided within the valve housing 11. The seat housing 15 is press-fitted in a lower end of the sleeve 12. A valve seat 16 is provided within the seat housing 15. The valve seat 16 forms an oil passage in accordance with sliding of the armature 14. The sleeve 12 and seat housing 15 may have an integrated structure in order to simplify the manufacturing process. In this case, the sleeve 12 is opened to the magnet core 13.

Each of the valve housing 11 and seat housing 15 is formed, at one side thereof, with a hole communicating with an oil inlet passage 11a of the modulator block (not shown). An oil outlet passage 15a is formed at the seat housing 15 to communicate with an orifice 17 of the valve sheet 16, and thus to allow discharge of oil. The orifice 17 is selectively opened or closed by the armature 14 and a ball 18.

Meanwhile, a return spring 19 is installed between the armature 14 and the magnet core 13 to urge the armature 14 toward the valve seat 16. As the return spring 19 urges the armature 14 toward the valve seat 16, the armature 14 is moved to close the orifice of the valve seat 16.

In accordance with the illustrated embodiment, the armature 14 is provided with a cylindrical shim core 20 disposed within the armature 14. The shim core 20 may be installed in the armature 14 through insert molding. The shim core 20 is made of a metal material, similarly to the armature 14. However, the shim core 20 has non-magnetic characteristics. A Material having such physical properties includes stainless steel such as SUS or STS. The shim core 20 has one end contacting the ball 18. The other end of the shim core 20 is slightly protruded beyond an end of the armature 14 facing the magnet core 13. As shown in the enlarged view portion of FIG. 2, the height difference H between the armature 14 and the shim core 20 is equal to the height of the conventional sol-shim. As the shim core 20 is provided at the armature 14, it may be possible to eliminate residual electromagnetic force remaining due to the shim core 20. In this case, the armature 14 may be manufactured through forging because the structure of the armature 14 is simple.

In the solenoid valve 10 configured as described above, the armature 14 is moved toward the magnet core 13 by magnetic force applied to the armature 14. In order to generate a magnetic field, the coil 30 is fitted around the magnet core 13 and sleeve 12.

When an electromagnetic field is generated as current is applied to the coil 30, magnetic flux flows through the magnet core 13. As a result, the armature 14 is moved toward the magnet core 13, thereby opening the orifice 17. Accordingly, oil introduced through the oil inlet passage 11a is discharged from the oil outlet passage 15a via the opened orifice 17.

When current applied to the coil 30 is cut off, the armature 14 is moved toward the valve seat 16 by elastic force of the return spring 18, thereby closing the fluid outlet passage 15a. This operation may be rapidly carried out by virtue of the shim core 20 restricting residual electromagnetic force.

As apparent from the above description, the solenoid valve according to each aspect of the present invention has a simple structure, thereby being capable of achieving easy machining and assembly and reducing cost.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A solenoid valve for a brake system including a sleeve fitted in a modulator block, an armature slidably disposed in the sleeve, a magnet core fitted in the sleeve at one side of the sleeve, to generate an electromagnetic force causing the armature to slide, a seat housing fitted in the sleeve at the other side of the sleeve and formed with an oil inlet passage and an oil outlet passage, and a valve seat disposed within the seat housing and formed with an orifice to be opened or closed in accordance with sliding of the armature,
wherein the armature comprises a shim core disposed in the armature in a longitudinal direction of the armature, to prevent generation of a residual electromagnetic force, and the shim core is protruded toward the magnet core beyond the armature.

2. The solenoid valve according to claim 1, wherein the armature and the shim core are formed through insert molding.

3. The solenoid valve according to claim 1, wherein the shim core has a cylindrical shape, and has an end contacting a ball to open or close the orifice.

4. The solenoid valve according to any one of claims 1 to 3, wherein the shim core is a non-magnetic body.

5. A solenoid valve for a brake system comprising:
a sleeve fitted in a modulator block;
an armature slidably disposed in the sleeve;
a magnet core fitted in the sleeve at one side of the sleeve, to generate an electromagnetic force causing the armature to slide;
a seat housing fitted in the sleeve at the other side of the sleeve and formed with an oil inlet passage and an oil outlet passage;
a valve seat disposed within the seat housing and formed with an orifice to be opened or closed in accordance with the slid of the armature; and
a shim core formed in the armature through insert molding while having a cylindrical shape, the shim core having an end protruded into a space facing the magnet core, and an opposite end contacting the orifice.

6. The solenoid valve according to claim 5, wherein the shim core is made of SUS.
